(19) United States
(12) Patent Application Publication
(10) Pub. No.: US 2014/0136262 A1
(43) Pub. Date: May 15, 2014

(54) SERVICE MANAGEMENT SYSTEM AND METHODS FOR FACILITATING ON-DEMAND SERVICES

(71) Applicant: goHairCut.com, Inc., San Jose, CA (US)

(72) Inventors: Md Annis Uzzaman, Saratoga, CA (US); Shoo Ming Lee, Singaport (SG)

(21) Appl. No.: 13/674,823

(22) Filed: Nov. 12, 2012

(51) Int. Cl. G06Q 10/06

(52) U.S. Cl. CPC G06Q 10/06311
USPC 705/7.19; 705/7.13

(57) ABSTRACT

A streamlined reservation and logistics system for providing convenient on-demand services is described. The streamlined reservation system integrates mobile technology, and enhanced routing and tracking to provide a unique and scalable reservation system. The on-demand services provided can be any on-demand services such as, for example, on-demand barbershop and/or salon services.

### CLAIM OF PRIORITY

This application claims priority to U.S. Provisional Patent Application No. 61/558,920 entitled “SYSTEMS AND METHODS FOR MANAGING MOBILE AND FIXED HAIR SALONS”, which was filed on Nov. 11, 2011, Attorney Docket No. 78909-8001.US00, the contents of which are expressly incorporated by reference herein.

### BACKGROUND

Today's hair care industry lacks convenience for both customers and salons. For example, traditional hair care facilities, such as salons and barbershops, operate during limited hours and are often closed on Sundays and holidays. The lack of convenience often results in difficulties in scheduling appointments for customers. These difficulties may become especially apparent for people that require frequent visits to a hair care facility, such as families with children and people having mobility difficulties (e.g., such as people with disabilities and the elderly).

Further, salons are also inconvenienced by the status quo of the hair care industry. For example, most salons cannot afford the additional expense of hiring a receptionist. Thus, stylists are required to operate the phones, schedule appointments, and return telephone calls often resulting in unhappy stylists and errors in scheduling.

### SUMMARY

The systems and methods describe a streamlined reservation and logistics system for providing convenient and competitively priced on-demand services anywhere, anytime. The streamlined systems promote better lifestyles characterized by unparalleled convenience. The streamlined reservation system integrates mobile technology, enhanced methodology, and tracking to provide a unique and scalable reservation system. The services provided can be any on-demand services such as, for example, on-demand barbershop and/or salon services.

Systems and methods for operating mobile and fixed hair salons are described herein. More specifically, the systems and methods disclosed provide for on demand hair care solutions and for a universal reservation system that can be embedded or incorporated into hair care facilities websites, Facebook pages, yelp links, etc. This flexibility facilitates appointment scheduling and other calendaring.

In one embodiment, the system maintains a dynamic database of available mobile hair salons, stylists and other professionals. This allows a stylist to check in to get business as needed, or to simply use our service as their calendaring system. A customer's request for a salon service is routed based on the customer requirements, with the default being to route to an available mobile salon. The system also provides a scheduling and calendaring widget which salons and stylists can incorporate into their website, FACEBOOK®, page, YELP® link, etc., to facilitate appointment scheduling and other calendaring.

On demand hair care provides a solution to the inconvenience that consumers of the hair care industry are burdened with. The on demand hair care described herein satisfies consumer craving for an on-demand lifestyle by making scheduling appointments easy, efficient, and painless. The on demand aspects are literally available anytime resulting in unparalleled convenience. Advantageously, the systems and methods disclosed herein provide fast and convenient hair care right at your door step.

In addition, a universal reservation system provides an efficient and easy to use software platform that can be embedded into the website of a hair care facility. The website allows customers and salons to schedule appointments automatically and painlessly. The universal reservation system platform will streamline the reservation process for salons that cannot afford to dedicate time or money towards hiring a receptionist or handling the reservations themselves. Additionally, the universal reservation system aims to be the universal standard for any salon or barbershop to make reservations. Customers will feel more comfortable making reservations from our easy to use platform.

In an embodiment, a method of routing service requests using a service management system is disclosed. The method comprises receiving, at the service management system, a service request from a customer, the service request including a requested time period and a first service tier; identifying, at the service management system, a first list of resources associated with the first service tier, the first list of resources being available during the requested time period; in response to the first list not including one or more resources, identifying, at the service management system, a second list of resources associated with a second service tier, the second list of resources being available during the requested time period; and routing the service request to a highest tiered available resource for servicing, wherein the first list of resources includes resources of a higher tier than the second list of resources.

In another embodiment, the service request comprises a salon service request.

In another embodiment, the first service tier is associated with mobile staff resources having salon equipped vehicles and the second service tier is associated with mobile freelance stylist resources.

In another embodiment, the mobile freelance stylist resources are available when checked in to the service management system.

In another embodiment, the method further comprises in response to the second list not including one or more resources, identifying, at the service management system, a third list of resources associated with a third service tier, the third list of resources being available during the requested time period; and wherein the second list of resources includes resources of a higher tier than the third list of resources.

In another embodiment, the method further comprises verifying the service request with the customer prior to routing.

In another embodiment, the method further comprises receiving, at the service management system, another service request from the customer responsive to the customer not verifying the service request, the another service request including a new requested time period and the first service.

In another embodiment, the routing the service request to the highest tiered available resource further comprises scheduling the service request in the service management system.

In another embodiment, the service request is received from a portable electronic device via a communication network.

In another embodiment, the service request is received from a plain old telephone system via a communication network.

In one embodiment, the system maintains a dynamic database of available mobile hair salons, stylists and other professionals. This allows a stylist to check in to get business as needed, or to simply use the service a personal calendaring system. A customer's request for salon service is routed based on the customer requirements, with the default being to route the request to an available mobile salon. The system also provides a scheduling and calendaring widget which salons and stylists can incorporate into their website, FACEBOOK® page, YELP® link, etc., to facilitate appointment scheduling and calendaring.

### BRIEF DESCRIPTION OF THE DRAWINGS

FIG. 1 depicts a block diagram of an example environment suitable for managing mobile and fixed hair salons.

FIG. 2 depicts a block diagram of the components of a host system for managing mobile and fixed hair salons.

FIG. 3 depicts a flow chart illustrating an example process for managing mobile and fixed hair salons.

FIGS. 4A and 4B depict examples user interfaces illustrating operation of a universal reservation system.

FIG. 5 depicts a block diagram of another example environment suitable for managing mobile and fixed hair salons.

FIG. 6 depicts a block diagram of the components of a host system for managing mobile and fixed hair salons.

FIG. 7 depicts a flow chart illustrating the customer appointment process.

FIG. 8 depicts a flow chart illustrating the database appointment update process.

FIG. 9 shows a block diagram of the components of a portable stylist case.

FIG. 10 depicts a flow chart illustrating an example process for providing a service.

FIG. 11 depicts a flow chart illustrating an example mobile tool cleaning procedure.

FIG. 13 depicts a diagrammatic representation of a machine in the example form of a computer system within which a set of instructions, for causing the machine to perform any one or more of the methodologies discussed herein, may be executed.

### DETAILED DESCRIPTION

Embodiments of the present disclosure include examples of systems and methods for managing mobile and fixed hair care facilities and a universal reservation system.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The systems and methods described herein provide for systems and methods to manage and maintain mobile and fixed retail businesses by creating a network of service providers including individuals (i.e., staff and contractors) and one or more established base stores. In some embodiments, a base store may be established within each geographic region. Advantageously, the staff and contractors are available via a mobile service 24 hours a day, 7 days a week, 365 days a year.

Customers can access the services via a universal automated reservation system. The system provides various payment options including online pre-payment methods. Additionally, customers and/or service providers may review feedback, rankings, and other information specific to the service and/or the individual staff member or contractor. In some embodiments, the feedback may be provided by past customers and may be related to the service generally and/or the individually staff member or contractor performing the service. In some embodiments, the reviewable information may include access to work history, profitability, contract information, and/or background information including credit history and/or criminal history.

The following detailed description is discussed with particular reference to the hair care industry; however, the systems and methods described are equally applicable to a variety of industries. For example, the systems and methods described herein can be applied to any on-demand service such as, for example, a grooming business (e.g., hair salon, manicure/pedicure, hair removal/waxing, hair growth treatment, etc.), holistic treatment (e.g., massage, acupuncture, etc.), physician treatment (e.g., therapy, semi-urgent care, etc.), home repair (e.g., electricians, plumbing, etc.), domestic help (e.g., laundry, gardening, vacuuming, window cleaning, carpet cleaning, etc.), child/elderly care (e.g., babysitting, nursing care, etc.), education (e.g., tutoring, music lessons, computer training, etc.), on demand taxi or chauffer services (e.g., pick-up/drop-off people and items).

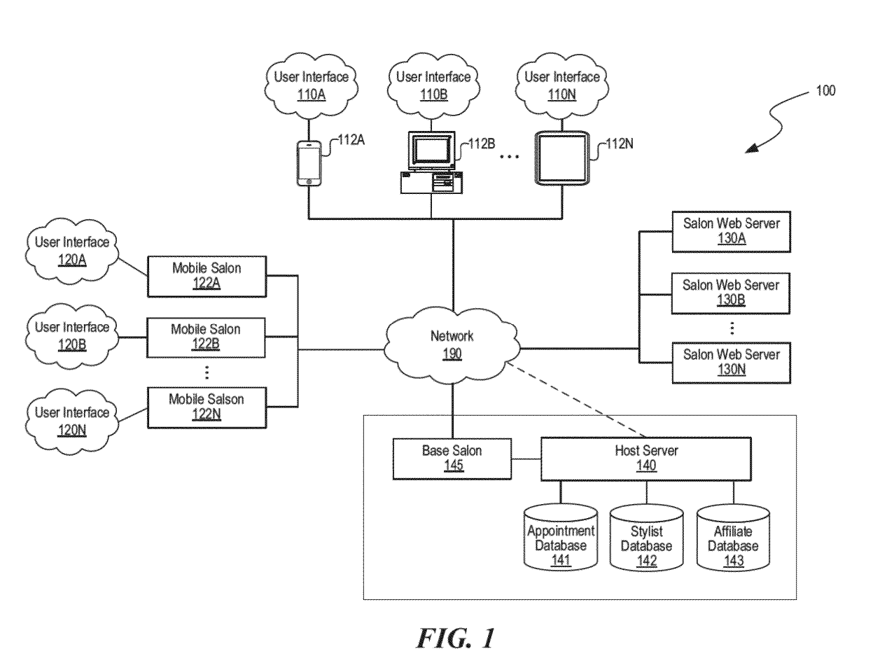

FIG. 1 depicts a block diagram illustrating an example environment 100 suitable for managing mobile and fixed hair salons, according to an embodiment. The example environment 100 includes a plurality of client devices 112A-N, a plurality of mobile salons 122A-N, a plurality of salon web servers 130A-N, a host server 140, databases 141-1143, a base salon 145, and a communication network 190. Although not shown, example environment 100 may further include plain old telephone systems that communicate with the host server through the communication network 190, and one or more social networking servers.

Host server 140 is configured to communicate with client devices 112A-N, mobile salons 122A-N, salon web servers 130A-N, and base salon 145 for managing mobile and fixed hair salons. For example, stylists (both full-time/part-time stylists and freelance stylists) may interact with the host server via a client device 112 in order to access calendaring and scheduling information. The host server 140 provides a dynamic database for these stylists allowing them to notify the host server 140 when they are available, reminding them about upcoming appointments, and providing an on-demand appointment engine.

Host server 140 may also include an administer interface providing scheduling a calendaring at the base salon 140. The base salon 140 may comprise a brick and mortar salon location providing salon services for walk-in clients and clients by appointment. The base salon 140 may include one or more areas for temporality parking or docking the mobile salons 122A-N. Stylists (not shown) can provide services at the base salon or one or more other brick and mortar locations (not shown) when not providing mobile salon services using the mobile salons 122A-N. In some embodiments, the host server 140 may be geographically co-located with the base salon 145.

The mobile salons 122A-N may comprise a fleet of vehicles equipped with one or more areas for providing salon services. For example, the fleet of vehicles may include one or more buses, min-vans, vans, etc. In some embodiments, the mobile salons include one or more chairs, and various salon tools, products, and equipment. Additionally, in some embodiments, the mobile fleet may include plumbing capabilities for washing hair, etc. and gas generators or batteries for power.

In some embodiments, the mobile salons 122A-N may have wireless network capabilities for interacting with the communication network 190 and/or satellite location services for providing location and tracking information to the host server 140.

The salon web servers 130A-N may comprise servers operated by affiliated salons that are in communication with host server 140. In some embodiments, these servers may include embedded software applications that enable client devices 110 to schedule appointments and calendar. The embedded software applications may or may not interact with host server 140. For example, a customer may access the salon's website and schedule an appointment thereon using the embedded universal software application. Similarly, a stylist for the salon may access calendaring information via a mobile device by accessing the website. In some embodiments, a mobile application may be provided to the client device 112 in lieu of or in addition to the website.

The plurality of client devices 112A-N can be any system and/or device, and/or any combination of devices/systems that is able to establish a connection with another device, a server and/or other systems. The client devices 112A-N typically include a user interface 110A-N that includes an input device or devices and a display or other output functionalities to present data exchanged between the devices to a user. For example, the client devices can include, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone, etc. The client devices 112A-N are coupled to communication network 190.

Additionally, in some embodiments, one or more client devices 112A-N may include a plain old telephone device. The device may be connected to communication network 190 through a PSTN (not shown). Alternatively, the PSTN may be included within communication network 190.

The network 190, to which the client devices 112A-N are coupled, can be a telephonic network, an open network, such as the Internet, or a private network, such as an intranet and/or the extranet. For example, the Internet can provide file transfer, remote log in, email, news, RSS, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

The network 190 can be any collection of distinct networks operating wholly or partially in conjunction to provide connectivity to the client devices and host server, and can appear as one or more networks to the serviced systems and devices. In one embodiment, communications to and from the client devices 112A-N can be achieved by, an open network, such as the Internet, or a private network, such as an intranet and/or the extranet.

The client devices 112A-N can be coupled to the network (e.g., Internet) via a dial-up connection, a digital subscriber loop (DSL, ADSL), cable modem, wireless interfaces, and/or other types of connection. Thus, the client devices 112A-N can communicate with remote servers (e.g., web server, host server, mail server, or instant messaging server) that provide access to user interfaces of the World Wide Web via a web browser, for example.

Databases 141-143 can store information such as software, descriptive data, images, system information, drivers, and/or any other data item utilized by parts of the host server 120 for operation. Databases 141-143 can be managed by a database management system (DBMS), for example but not limited to, Oracle, DB2, Microsoft Access, Microsoft SQL Server, PostgreSQL, MySQL, FileMaker, etc. Databases 141-143 can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package. As shown, the databases 141-143 are coupled to host server 140. It is appreciated that, in some embodiments, databases 141-143 may be coupled directly to network 190.

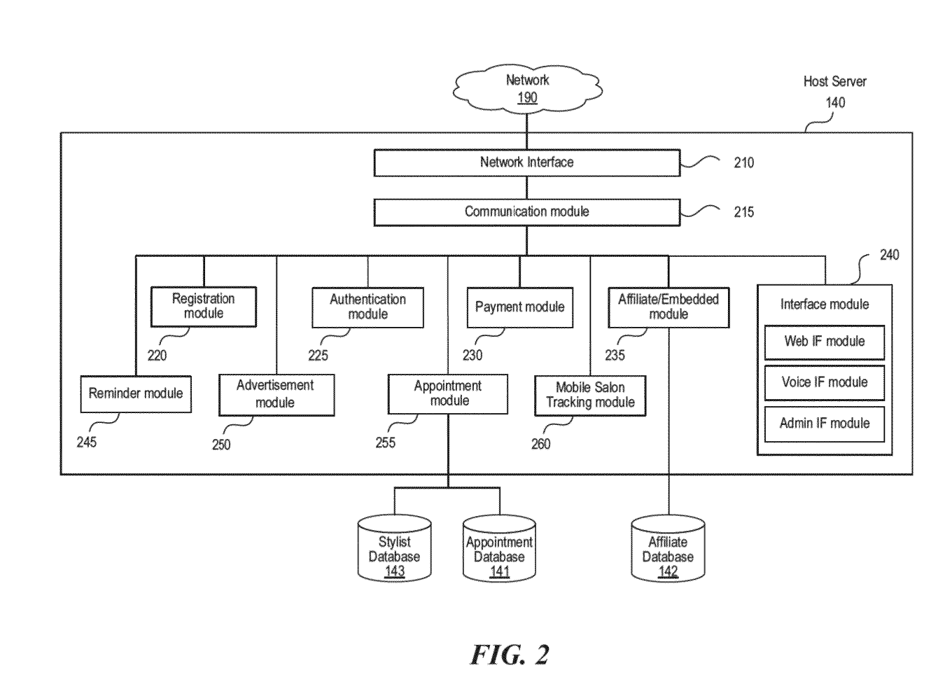

FIG. 2 depicts a block diagram of the components of a host server 140 for managing mobile and fixed hair salons, according to an embodiment. The host server 140 is coupled to databases 141-143 which together provide a dynamic database for managing the mobile and fixed hair salons.

The host server 140, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 2, the host server 140 includes a network interface 210, a registration module 220, an authentication module 225, a payment module 230, a affiliate/embedded control module 235, an interface module 240, a reminder module 245, an advertisement module 250, an appointment/calendar module 255, and a mobile salon tracking module 260. Additional or fewer modules can be included.

The host server 120 can be communicatively coupled to an appointment database 141, an affiliate database 142, and a stylist database 143, as illustrated in FIG. 2. In some embodiments, the appointment database 141, the affiliate database 142, and the stylist database 143 are partially or wholly internal to the host server 140. In other embodiments, the appointment database 141, the affiliate database 142, and/or the stylist database 143 are coupled to the host server 140 over network 190.

In the example of FIG. 2, the network interface 210 can be one or more networking devices that enable the host server 140 to mediate data in a network with an entity that is external to the server, through any known and/or convenient communications protocol supported by the host and the external entity. The network interface 210 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

In the example of FIG. 2, the host server 140 includes the communications module 215 communicatively coupled to the network interface 210 to manage a communication session over a plurality of communications protocols. In one embodiment, the communications module 215 receives data (e.g., audio data, textual data, audio files, etc.), information, commands, requests (e.g., text and/or audio-based), and/or text-based messages over a network.

Since the communications module 215 is typically compatible with receiving and/or interpreting data originating from various communication protocols, the communications module 215 is able to establish parallel and/or serial communication sessions with users of remote client devices, advertisers, content providers, and streaming services for data and command exchange (e.g., user information and/or user content).

One embodiment of the host server 140 includes a registration module 220. The registration module 220 can be any combination of software agents and/or hardware components able to register customers, stylists, freelance stylists, and/or affiliated salons or advertisers with the system to create new accounts with the system. Stylists can register to receive regular notifications and access the calendaring system. Customer can register to make an on-demand appointment. Freelance stylists can register to be routed appointments when the regular staff stylists are not available. Affiliated salons may register to be routed appointments when the regularly staffed stylists and the freelance stylists are unavailable or when the customer requests the selected affiliated salon. Advertisers can register to provide advertisements on the website or deliver advertisements and/or coupons directly to consumers.

One embodiment of the host server 140 includes an authentication module 225. The authentication module 225 can be any combination of software agents and/or hardware components able to authenticate customers, stylists, freelance stylists, and/or affiliated salons or advertisers. In some embodiments, authentication occurs by associating a username and password with an existing user account. Unauthorized users can be directed to register with the system. In some embodiments, freelance stylists can check in to the system when they are available. This system will then route overflow appointments (e.g., when staff stylist not available) to the available freelance stylists.

One embodiment of the host server 140 includes a payment module 230. The payment module 230 can be any combination of software agents and/or hardware components able to present and process payment information. The payment module 230 may be configured to process and/or track paypal payments, credit card transactions, etc. In some embodiments, the payment module presents and provides for online pre-payments, payment plans, and payment processing. In some embodiments, the payment module 230 provides for easy, safe, global payment. Additionally, the payment rates are posted and fixed. Although optional, in some embodiments, customers can return to the system to insert tip information after the service has been provided. In other embodiments, tipping information can be provided prior to the service—and be revoked in the event of poor or late service. While rates may vary among staff and contractors in some embodiments, the rates are fixed and posted.

One embodiment of the host server 140 includes an affiliate/embedded control module 235. In some embodiments, the affiliate/embedded control module 235 can be any combination of software agents and/or hardware components able to integrate the features and functions of the host server 140 into other sites such as, for example, salon web servers. In addition, the affiliate control module 235 may provide an affiliate interface allowing the affiliates to modify profiles, view transactions, and/or access databases 141-143.

One embodiment of the host server 140 includes an interface module 240. In some embodiments, the interface module 420 includes a web interface module, a voice interface module, and/or administrator interface module. The web interface module allows customers and/or stylists to access the system via client devices or plain old telephone devices. For example, a customer may access the system by visiting the website www.gohaircut.com, accessing an application stored on a client device, and/or by calling a 1-800 number (e.g., 1-800-haircut). In some embodiments, the 1-800 number may be processed by an automated voice system that allows the user to make an appointment. In other embodiments, a scheduler at the base salon may answer the phone and schedule the appointment via the administrator interface.

One embodiment of the host server 140 includes a reminder module 245. The reminder module can be any combination of software agents and/or hardware components able to identify stylists (both staff and freelance) and remind them about upcoming, and/or late appointments.

One embodiment of the host server 140 includes an advertisement module 250. The advertisement module 250 can be any combination of software agents and/or hardware components able to push and/or otherwise control advertisements on the website and/or mobile applications. In some embodiments, the advertisement module may also provide an interface for advertisers to interact. In some cases, the advertisement module can track, provide, and notify customers of rewards they have earned for using the system.

One embodiment of the host server 140 includes an appointment module 255. The appointment module 255 can be any combination of software agents and/or hardware components able to process customer requests, route the customer requests, provide scheduling and calendar information to stylists, etc. In some embodiments, the appointment module 255 interacts with the stylist database 143 and the appointment database 141. All of the information stored in the databases can be used to route appointments and create/adjust scheduling and calendaring options. For example, traffic reports and location information may be used when routing salon service requests to mobile salons.

The appointment database 141 includes dynamic information used for creating and maintaining the scheduling and calendaring options. This information includes, but is not limited to all currently scheduled appointments and assignments (routed appointments). The stylist database 143 may include dynamic information about each of the staff stylists and/or freelance stylists. This information may include availability, contact information, feedback, ratings, payment information, etc.

One embodiment of the host server 140 includes a mobile salon tracking module 260. The mobile salon tracking module 260 can be any combination of software agents and/or hardware components able to track and store location information related to the mobile salon fleet. In some embodiments, this information is used to route an appointment request to a specific mobile salon. In some embodiments, the mobile salon tracking module 260 may additionally receive and/or provide traffic report information. This information may also be used by appointment module 255 when determining appropriate routing for the requests.

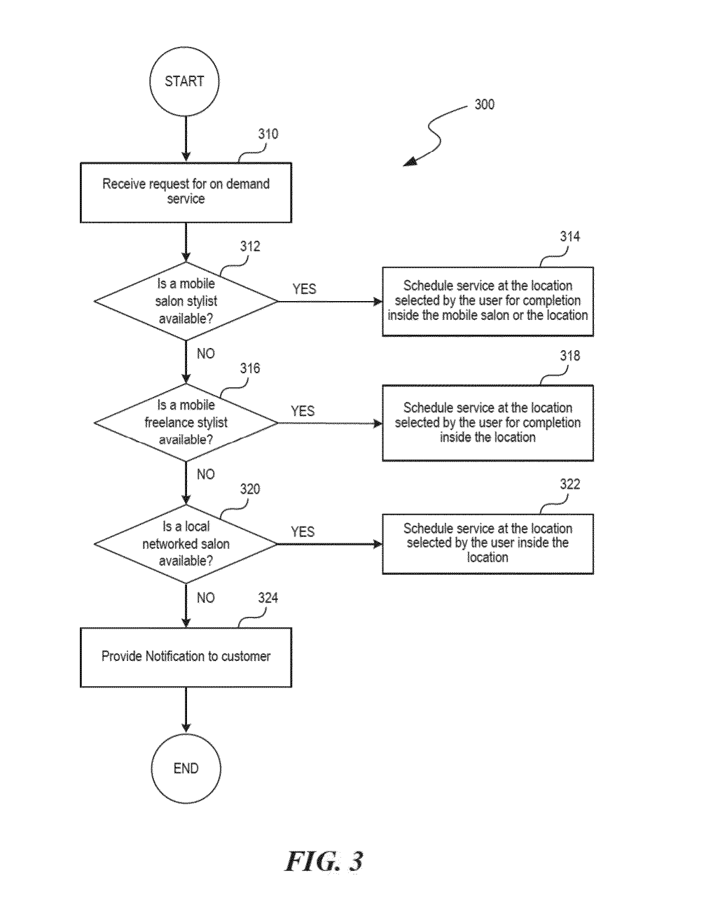

FIG. 3 depicts a flow chart illustrating an example process 300 for managing mobile and fixed hair salons, according to an embodiment. More specifically, process 300 describes the process of routing a customer request for service according to one embodiment. To begin, in process 310 a request for service is received. As discussed above, the request for service can be received in any number of ways including via the website, via a mobile application, and/or via the telephone.

In process 312, the host system determines whether a staff stylist is available, and if so, in process 314, the host system schedules the requested service at the located selected by the user for completion inside the mobile salon or the customers location of choice (e.g., inside the customer's house). The system may choose an individual mobile salon based on availability of that salon, relative location, customer requests, etc.

In process 316, the host system determines whether a freelance stylist is available, and if so, in process 318, the host system schedules the requested service at the customers location of choice (e.g., inside the customer's house). The system may choose a freelance stylist based on any number of factors including, but not limited to, availability, ranking, contract status (e.g., may choose the cheapest stylists or those that have contracts more favorable to the system), location, freelance stylist preference, and/or customer preferences.

In process 320, the host system determines whether a local networked (i.e., affiliated salon) is available, and if so, at process 322 schedules the requested service at the affiliated salon. In some instances, customers may request a specified salon or choose a salon within a specified distance from their current location.

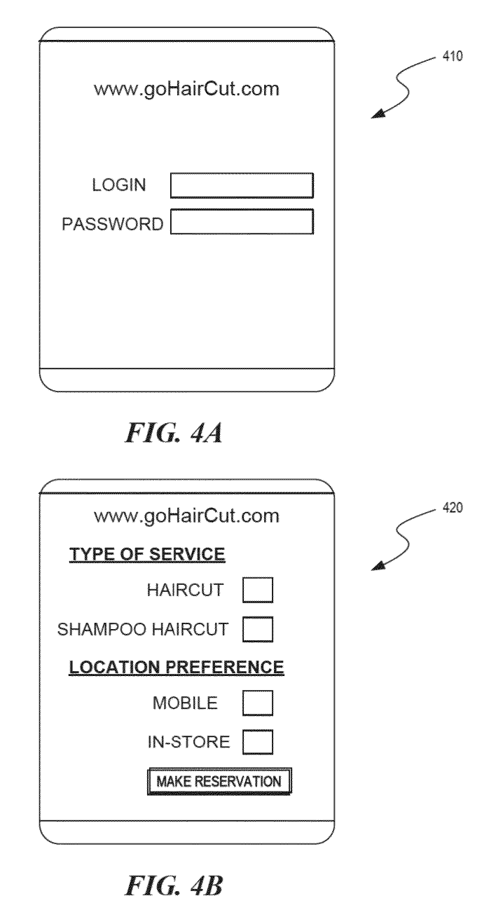

FIGS. 4A and 4B depict examples user interfaces 410 and 420 illustrating operation of a universal reservation system, according to an embodiment. Interfaces 410 and 420 show examples of the interfaces that may be provided to customers via the website, via an affiliated website (e.g., embedded), and/or via a mobile application. Although not shown in this example, advertisements may also be displayed.

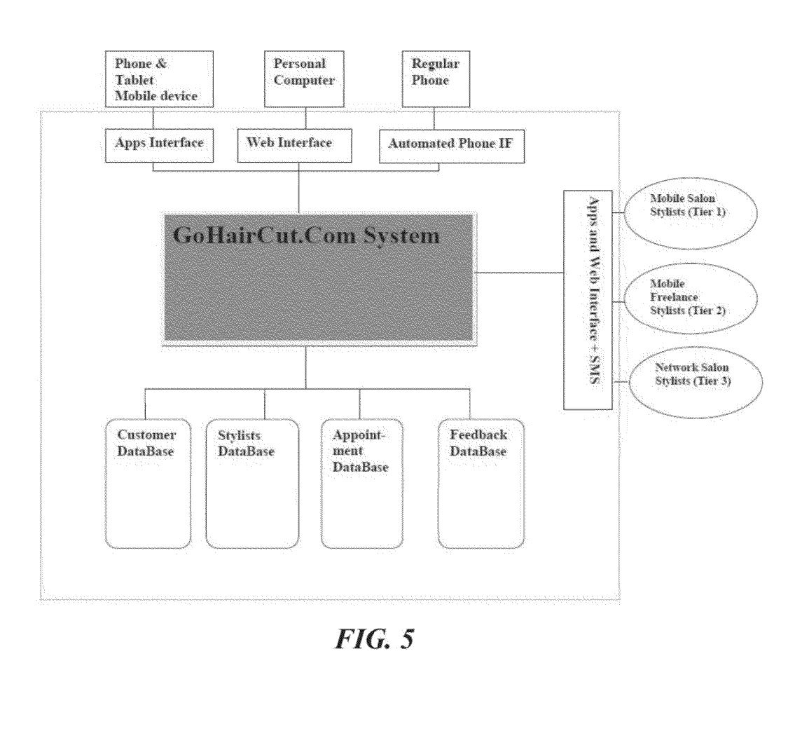

FIG. 5 depicts a block diagram of an example environment 500 suitable for managing mobile and fixed hair salons, according to an embodiment. In particular, FIG. 5 illustrates the gohaircut.com system interfaces. It is appreciated that other environments are also possible

Phone and tablet mobile devices interface with an application interface. Personal computers interface via a web interface. Telephone calls received via a mobile device or a regular (POTS device) are handled via an automated phone interface. The system maintains various databases and provides universal interfaces for accessing the database information. The databases may include, but are not limited to a customer database, a stylist database, an appointment database and a feedback database.

An application and web interface including SMS capabilities is also provided to communicate with various tiers of the system. For example, mobile salon stylists (tier 1), mobile freelance stylists (tier 2), and network salons (tier 3) may communicate with the system via the web interface with SMS.

The customer database may include a variety of information related to a customer including name, address, telephone number, credit card number, service history, etc. This information may be encrypted or otherwise maintained for security. The stylist database may include a variety of information on the staff stylists and or contractor stylists. This information may include but is not limited to name, rate, contract information, history, rating, favorability, etc. The appointment database is accessed to identify scheduling availability and maintained to keep track of the scheduled appointments. The appointment database may trigger alerts for stylists and/or provide other information. The feedback database provides a place for feedback and other information to be entered and accessed for customers and/or management.

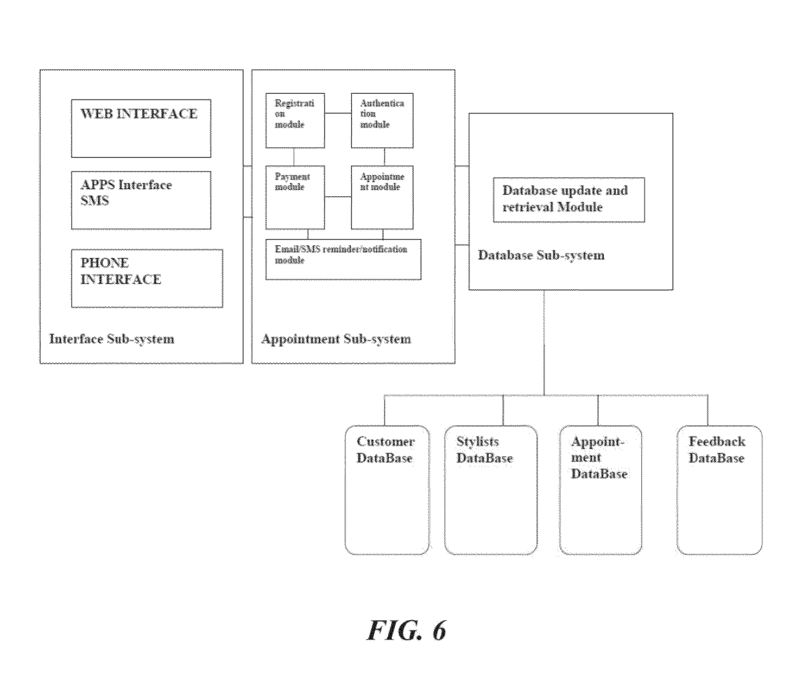

FIG. 6 depicts a block diagram of the components of a host system for managing mobile and fixed hair salons, according to an embodiment. In particular, various subsystems of the system described with reference to FIG. 5 are disclosed in FIG. 6.

An interface subsystem includes a web interface, an application interface, and a phone interface. An Appointment subsystem includes a registration module, an authentication module, a payment module, an appointment module, and a reminder/notification module. A database subsystem includes a database update and retrieval module. As shown in this example, the database subsystem also interfaces with the various databases.

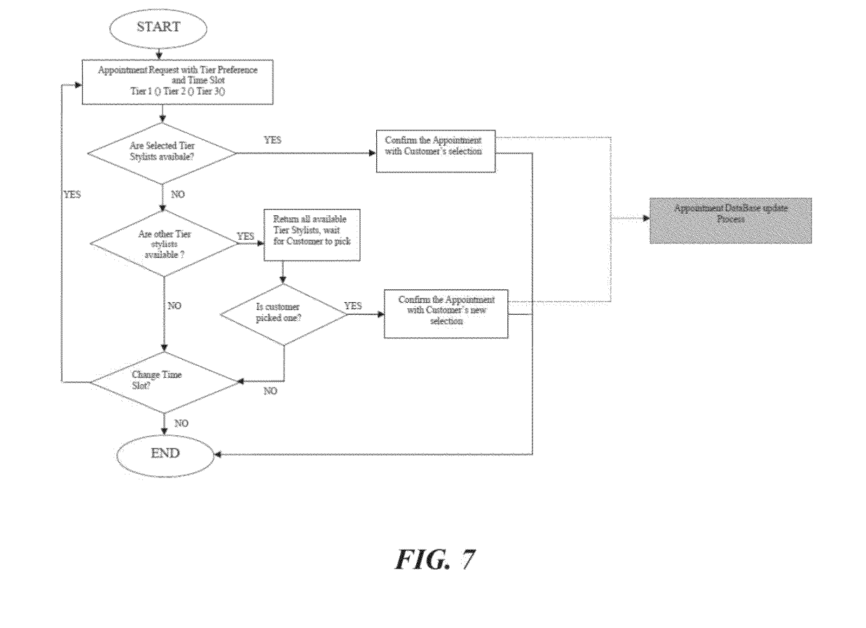

FIG. 7 depicts a flow chart illustrating the customer appointment process, according to an embodiment. In the example of FIG. 7, an appointment request is first received via the interface subsystem. The appointment request includes tier preference (e.g., tier 1, tier 2, and/or tier 3) and one or more time slots. The system then determines whether the selected tier stylists are available. If so, the appointment is confirmed with the customer and the appointment database is updated.

Conversely, if the appoint is not confirmed then the system determines whether other tier stylists are available. If so, the system returns (i.e., presents to the customer via the accessed interface) the available tier stylists and prompts the user for selection of a tier. If the customer selects one of the available tiers then the appointment is confirmed with the customer and the appointment database is updated.

However, if the customer does not select an available tier then the user may be prompted to change slot time. In alternate configurations, the user selects various slot times initially based on a rack and the available tiers are presented based on each slot time.

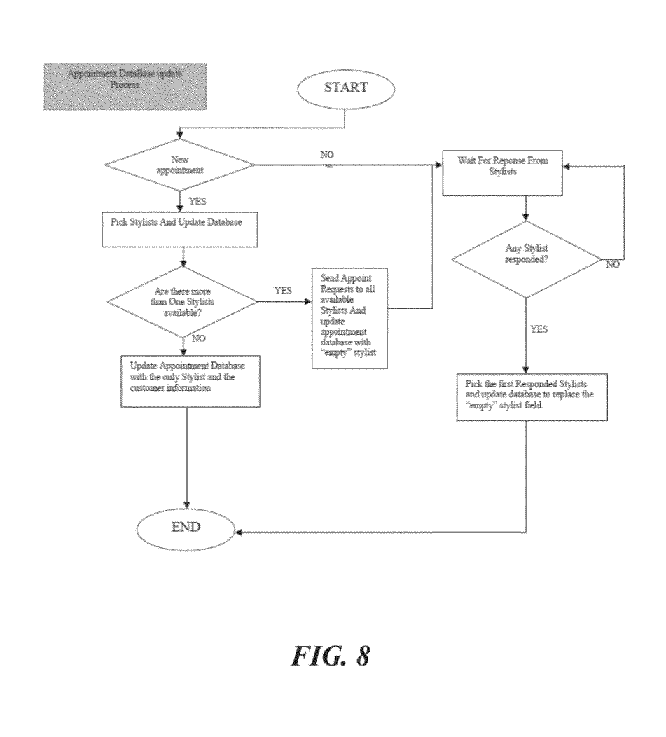

FIG. 8 depicts a flow chart illustrating the database appointment update process, according to an embodiment. To begin, the system waits to a new appointment to arrive. When a new appointment arrives, one or more available stylists are selected and the database is updated. If more than one stylist is selected, then the system sends an appoint request to all available stylists and updates the appointment database with an empty value for the stylist. The system then waits for a response from one or more of the stylists and picks the first to respond. It is appreciated that other stylist selection mechanisms are also possible. Lastly, the appointment database is updated.

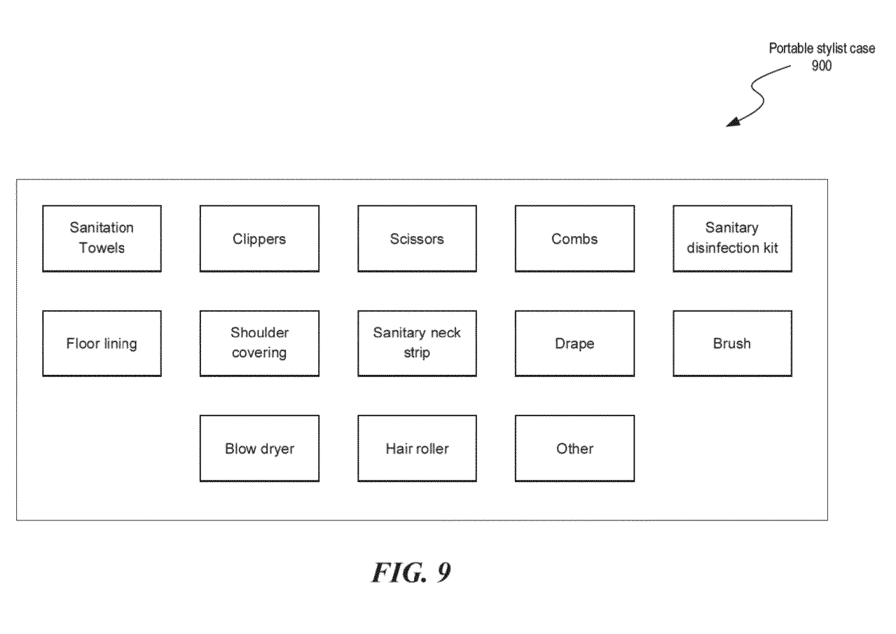

FIG. 9 shows a block diagram of the components of a portable stylist case 900, according to an embodiment. The portable stylist case 900 includes a number of components such as, for example, sanitation towels, clippers, scissors, combs, a sanitary disinfection kit, floor lining, shoulder covering, sanitary neck strips, drapes, a brush, a blow dryer, a hair roller. Additional of fewer components may also be included in the portable sylist case 900. Although not shown, the portable stylist case 900, may have wheels allowing a stylist to quickly and easily move the portable case from one client's location to the next.

In one embodiment, each component fits into a particular location of the portable stylist case 900. Additionally, when opened, the case can function as a workstation. An example of a portable stylist case functioning as a workstation when opened is illustrated and discussed in greater detail with respect to FIG. 12.

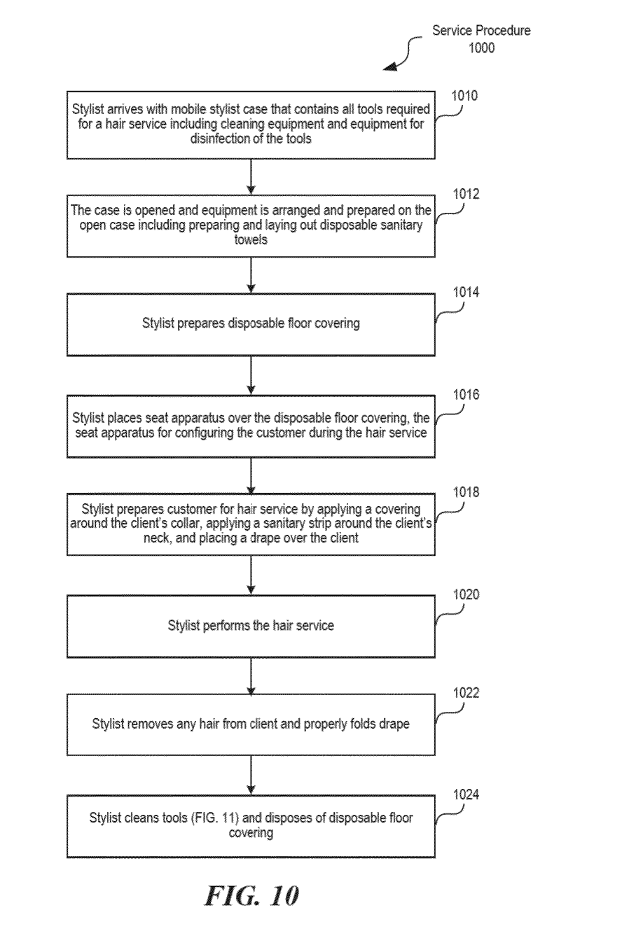

FIG. 10 depicts a flow chart illustrating an example process for providing a service, according to an embodiment. More specifically, the example of FIG. 10 illustrates an on-demand hair service procedure 1000 that is performed by a stylist utilizing a portable stylist case such as, for example, the portable stylist case 900 of FIG. 9.

To begin, in process 1010, a stylist arrives with a mobile stylist case that contains all of the tools (or components) required for a hair service including cleaning equipment and equipment for disinfection of the tools. In process 1012, the stylist opens the case and arranges and/or prepares the equipment (tools and/or components). The preparation can include preparing and laying out disposable sanitary towels. The portable stylist case 900 opens allowing the stylist to have easy access to each of the tools. In process 1014, the stylist prepares the disposable floor covering. The disposable floor covering may be any material that can aid in quick and painless clean-up. In one embodiment, the disposable floor covering can be plastic as shown in FIG. 12. Conversely, in some embodiments, the disposable floor covering can be biodegradable and/or otherwise washable, reusable, etc.

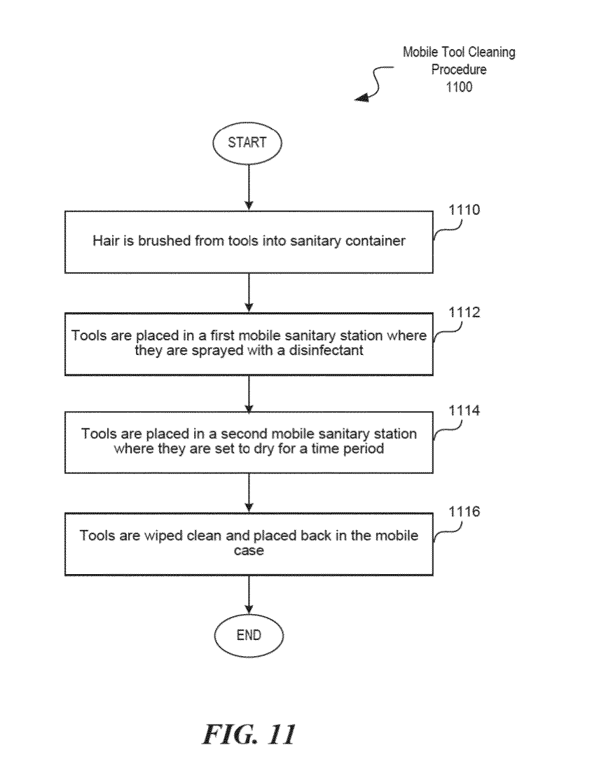

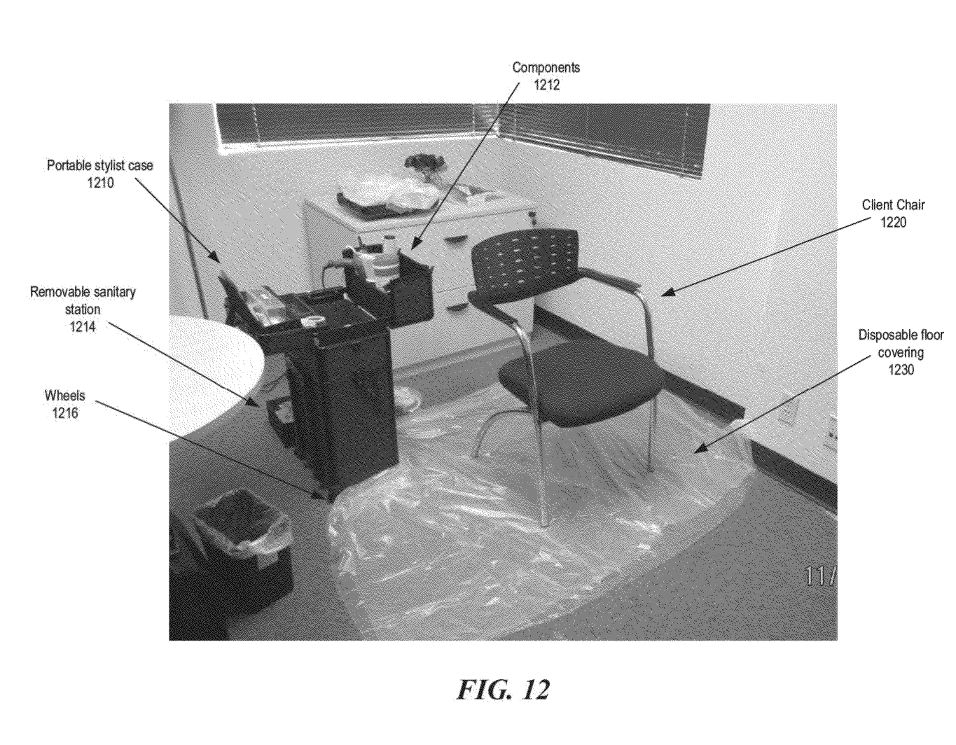

In process 1016, the stylist places a seat apparatus (e.g., chair) over the disposable floor covering. The seat apparatus is configured to support the customer during the service. In one embodiment, a client chair is utilized. In another, embodiment, the stylist can bring a chair that can be removably attached to the portable stylist case. In process 1018, the stylist prepares the customer for hair service by applying a covering around the client's collar, applying a sanitary strip around the client's neck, and placing a drape over the client. In process 1020, the stylist performs the hair service. In process 1022, the stylist removes any hair from client and properly folds drape. Lastly, in process 1024, the stylist cleans tools (see FIG. 11) and disposes of disposable floor covering.

FIG. 11 depicts a flow chart illustrating an example mobile tool cleaning procedure 1100, according to an embodiment. The process can be performed by a stylist utilizing a portable stylist case that includes various tools such as, for example, the portable stylist case 900 of FIG. 9.

To begin, in process 1110, the stylist burses hair from the tools into a sanitary container. In one embodiment, each portable stylist case includes at least one sanitary container and a plurality of removable mobile sanitary stations. In process 1112, one or more tools (components) of the portable stylist case are placed in a first mobile sanitary station where the components are sprayed with a disinfectant. Alternatively or additionally, the components may be soaked, doused, and/or otherwise covered with disinfectant in order to be cleaned. In process 1114, the tools are optionally placed in a second mobile sanitary station where they are set to drive for a time period. Lastly, in process 1116, the tools are wiped clean and returned to a proper location in mobile case.

FIG. 12 shows an example environment for performing a service, according to an embodiment. More specifically, the example of FIG. 12 illustrates an environment in which an on-demand hair service can be performed by a stylist utilizing a portable stylist case. The environment includes a portable stylist case 1210, a client chair 1220, and a disposable floor covering 1230. The portable stylist case 1210 may be the portable stylist case 900 of FIG. 9; although alternative configurations are possible. The portable stylist case 1210 includes wheels 1216 for easy mobility and various components 1212. The portable stylist case 1210 also includes a removable sanitary station, which, as shown, is removed and placed next to the portable stylist case 1210. The portable stylist case 1210 also includes various disposable floor coverings for use based on the environment in which the service is performed.

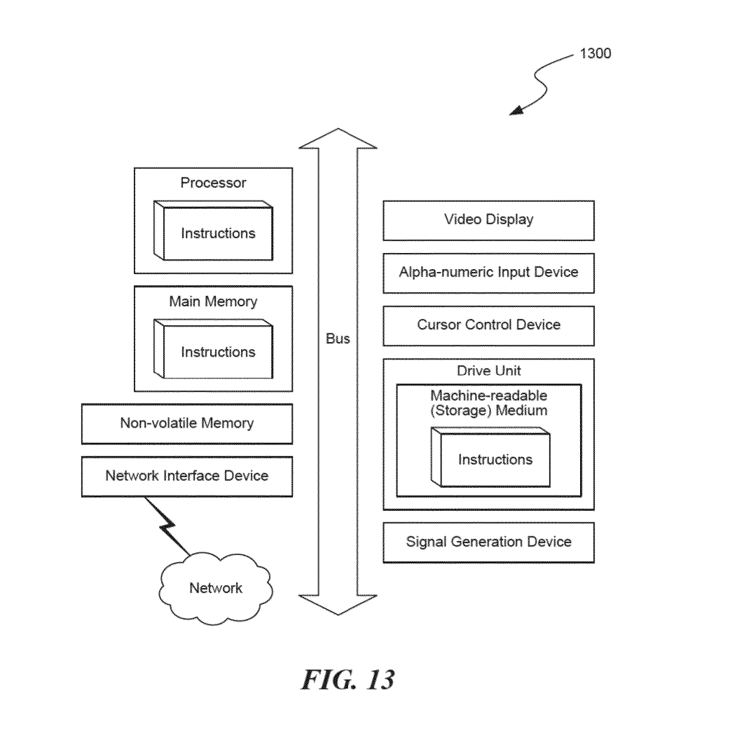

FIG. 13 shows a diagrammatic representation of a machine in the example form of a computer system 1300 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (e.g., a centralized or distributed database, and/or associated caches and servers) that store the one or more sets of instructions. The term “machine-readable medium” or “machine readable storage medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

What is claimed is:

1. A method of routing service requests using a service management system, the method comprising:
receiving, at the service management system, a service request from a customer, the service request including a requested time period and a first service tier;
identifying, at the service management system, a first list of resources associated with the first service tier, the first list of resources being available during the requested time period;
in response to the first list not including one or more resources, identifying, at the service management system, a second list of resources associated with a second service tier, the second list of resources being available during the requested time period; and
routing the service request to a highest tiered available resource for servicing, wherein the first list of resources includes resources of a higher tier than the second list of resources.

2. The method according to claim 1, wherein the service request comprises a salon service request.

3. The method according to claim 2, wherein the first service tier is associated with mobile staff resources having salon equipped vehicles and the second service tier is associated with mobile freelance stylist resources.

4. The method according to claim 3, wherein the mobile freelance stylist resources are available when checked in to the service management system.

5. The method of claim 1 further comprising:
in response to the second list not including one or more resources, identifying, at the service management system, a third list of resources associated with a third service tier, the third list of resources being available during the requested time period; and
wherein the second list of resources includes resources of a higher tier than the third list of resources.

6. The method according to claim 1, further comprising verifying the service request with the customer prior to routing.

7. The method according to claim 6, further comprising:
receiving, at the service management system, another service request from the customer responsive to the customer not verifying the service request, the another service request including a new requested time period and the first service.

8. The method according to claim 1, wherein routing the service request to the highest tiered available resource further comprises scheduling the service request in the service management system.

9. The method according to claim 1, wherein the service request is received from a portable electronic device via a communication network.

10. The method according to claim 1, wherein the service request is received from a plain old telephone system via a communication network.

11. A service management system comprising:
an interface configured to receive a service request from a customer and route the service request to a highest tiered available resource for servicing, wherein the service request includes a requested time period and a first service tier; and
a processing system configured to identify a first list of resources associated with the first service tier, the first list of resources being available during the requested time period, identify a second list of resources associated with a second service tier in response to the first list not including one or more resources, the second list of resources being available during the requested time period; and select the highest tiered available resource, wherein the first list of resources includes resources of a higher tier than the second list of resources.

12. The service management system according to claim 11, wherein the service request comprises a salon service request.

13. The service management system according to claim 12, wherein the first service tier is associated with mobile staff resources having salon equipped vehicles and the second service tier is associated with mobile freelance stylist resources.

14. The service management system according to claim 13, wherein the processing system is further configured to allow the mobile freelance stylist resources to check in to the service management system, wherein the mobile freelance stylist resources are available when checked in to the service management system.

15. The service management system according to claim 11, wherein the processing system is further configured to identify a third list of resources associated with a third service tier, the third list of resources being available during the requested time period, wherein the second list of resources includes resources of a higher tier than the third list of resources.

16. The service management system according to claim 11, wherein the processing system is further configured to verify the service request with the customer prior to routing.

17. The service management system according to claim 16, wherein the interface is further configured to receive another service request from the customer responsive to the customer not verifying the service request, the another service request including a new requested time period and the first service.

18. The service management system according to claim 11, wherein the processing system is further configured to direct routing schedule the service request in the service management system prior to routing.

19. The service management system according to claim 11, wherein the service request is received from one of a portable electronic device via a communication network or a plain old telephone system via a communication network.

20. A machine readable medium having instructions stored thereon that, when executed by the machine, cause the machine to:
receive a service request from a customer, the service request including a requested time period and a first service tier;
identify a first list of resources associated with the first service tier, the first list of resources being available during the requested time period;
in response to the first list not including one or more resources, identify a second list of resources associated with a second service tier, the second list of resources being available during the requested time period; and
route the service request to a highest tiered available resource for servicing, wherein the first list of resources includes resources of a higher tier than the second list of resources.

21. A method of routing a customer request, the method comprising:
receiving a salon service request from a customer, the service request including a requested time period;
determining if a mobile salon vehicle is available during the requested time period and, if so, scheduling the salon service request for completion by the mobile salon vehicle;
in response to the mobile salon vehicle not being available, determining if a freelance stylist is available and, if so, scheduling the salon service request for completion by the freelance stylist; and
in response to the freelance stylist not being available, determining if an affiliated salon is available and, if so, scheduling the salon service request for completion at the affiliated salon.

22. The method according to claim 21, further comprising verifying the reservation with the customer prior to scheduling.

23. The method according to claim 21, wherein the salon reservation request is received from a portable electronic device via a communication network.

24. The method according to claim 21, wherein the salon reservation request is received from a plain old telephone system.

25. The method according to claim 21, wherein the freelance stylist is available when checked in to the salon management system.

26. A machine readable medium having instructions stored thereon that, when executed by the machine, cause the machine to:
obtain scheduling information from an underlying salon system;
display the scheduling information to a customer over a communication network;
receive a customer's request for a salon service including one or more customer requirements; and
schedule the request based on the customer requirements on the underlying system.

27. A system comprising:
an interface configured to receive a customer service request; and
a processing system configured to process the customer service request and route the request to a mobile salon vehicle, a freelance stylist, or an affiliated salon based on information included in a dynamic database.

28. A system comprising:
an interface configured to receive a customer service request; and
a processing system configured to process the customer service request and route the request to a mobile service vehicle, a mobile freelance service provider, or an affiliated brick and mortar service provider based on information included in a dynamic service database.
